(19) United States
(12) Patent Application Publication
(10) Pub. No.: US 2025/0326143 A1
(43) Pub. Date: Oct. 23, 2025

(54) AMORPHOUS ALLOY SHAVER HAVING REPLACEABLE SHAVER HEAD, AND REPLACEMENT MODE THEREOF

(71) Applicant: Taizhou University, Taizhou (CN)

(72) Inventors: Ling SHAO, TAIZHOU (CN); Yingwei CHEN, TAIZHOU (CN); Liu ZHU, TAIZHOU (CN); Yingqi HUANG, TAIZHOU (CN); Mengliang CHEN, TAIZHOU (CN); Weiwei LI, TAIZHOU (CN); Na XUE, TAIZHOU (CN); Feilong XU, TAIZHOU (CN)

(21) Appl. No.: 19/258,544

(22) Filed: Jul. 2, 2025

Related U.S. Application Data
(63) Continuation of application No. PCT/CN2024/130462, filed on Nov. 7, 2024.

(30) Foreign Application Priority Data
Nov. 10, 2023 (CN) 202311496812.5

(51) Int. Cl. B26B 19/38; B26B 19/14

(52) U.S. Cl. CPC B26B 19/386; B26B 19/14

(57) ABSTRACT

An amorphous alloy shaver having a replaceable shaver head, comprises a shaver body, a release plate is fixedly connected to a top of the shaver body, a side surface of the shaver body is provided with a switch, the side surface of the shaver body is provided with a display screen, the side surface of the shaver body is provided with a charging slot, and a replacement device is arranged at a top of the release plate. By means of co-cooperation of a pressing force of a pressing block and components in the replacement device such as an airbag, a pressing plate, a snap-fit fastener and a snap-fit block, operation of jacking the snap-fit fastener up by the airbag is realized, which enhances convenience of a user such that a worn shaver head is replaced conveniently, and a service life of the shaver is prolonged.

### CROSS-REFERENCE TO RELATED APPLICATIONS

This application is a continuation of International Patent Application No. PCT/CN2024/130462 with a filing date of Nov. 7, 2024, designating the United States, now pending, and further claims priority to Chinese Patent Application No. 202311496812.5 with a filing date of Nov. 10, 2023. The content of the aforementioned applications, including any intervening amendments thereto, are incorporated herein by reference.

### TECHNICAL FIELD

The present invention belongs to the technical field of the amorphous alloy shaver, and in particular relates to an amorphous alloy shaver having a replaceable shaver head, and a replacement mode thereof.

### BACKGROUND OF THE PRESENT INVENTION

A shaver is an appliance for shaving beard, which belongs to a self-service tool and is mostly used by an adult man. The shaver can be separately divided into an electric shaver and a manual shaver according to a mode of use, and an effect of the manual shaver is the cleanest and thorough. Because the manual shaver is clean and thorough, low in cost and easy to operate, it has always occupied a high proportion in the market, and a shaver head of the manual shaver needs to be replaced regularly. However, for some shavers having the replaceable shaver head in the market, in order to realize a function of replacing the shaver head, an assembly structure of a button and a handle in the market is complicated, and parts such as a spring and a shaver head connector may need to be installed inside, so a production and assembly process is complicated, a production cost is high and a production capacity is low. General nursing equipment, including the shaver, a nose hair remover, a face washer, a hair scissor, etc., need to prepare a lot of personal care products. Too many devices will make it difficult to keep, and a plastic snap-fit fastener will also be used for fixation. After long-term use, the plastic snap-fit fastener will cause certain wear and tear, which will directly affect a fixation effect.

A published shaver head having balls and an electric shaver thereof publication number: CN 207373218 U comprises a fixed shaver blade and a supporting elastic sheet, which being stationary in the shaver head and between two ends of the shaver head; a movable shaver mounting frame, located below the fixed shaver blade in the shaver head and pressing down the supporting elastic sheet to move between two ends of the supporting elastic sheet; a movable shaver blade, movably arranged between the two ends of the shaver head along with the movable shaver mounting frame; and balls, arranged between the movable shaver mounting frame and the supporting elastic sheet, and the balls rolling along a moving path of the movable shaver mounting frame to support the movable shaver mounting frame to move between the two ends of the supporting elastic sheet, so that shaving teeth on a side edge of the movable shaver blade shaving movably. The advantages are that a sliding friction is changed into a rolling friction, which reduces a friction resistance. In the above application, it is difficult to realize the operation of replacing the blade through co-cooperation of the fixed shaver blade, the supporting elastic sheet and the movable shaver blade mounting frame, which shortens a service life of the shaver and reduces a comfort degree, which needs to be improved.

### SUMMARY OF THE PRESENT INVENTION

The present invention aims to provide an amorphous alloy shaver having a replaceable shaver head, and a replacement mode thereof. By means of co-cooperation of a pressing force of a pressing block and components in the replacement device such as an airbag, a pressing plate, a snap-fit fastener and a snap-fit block, the present invention realizes operation of jacking the snap-fit fastener up by the airbag, enhances convenience of a user such that the user replaces a worn shaver head conveniently, prolongs a service life of the shaver, improves operation accuracy of the device, reduces an operation error caused by position dislocation, ensures stable operation of the device, and improves a use comfort degree of the user, and thus solving the existing problems.

In order to solve the above technical problems, the present invention is realized by the following technical solution:

The present invention refers to an amorphous alloy shaver having a replaceable shaver head, comprising a shaver body, wherein a release plate is fixedly connected to a top of the shaver body, a side surface of the shaver body is provided with a switch, the side surface of the shaver body is provided with a display screen, the side surface of the shaver body is provided with a charging slot, and a replacement device is arranged at a top of the release plate; the replacement device comprises a bottom plate, a bottom of the bottom plate is fixedly connected to the top of the release plate, a protective plate is fixedly connected to a top of the bottom plate, a top plate is clamped to a top of the protective plate, a top of the top plate penetrates through an extrusion rod and is slippingly connected with a peripheral surface of the extrusion rod, one end of the extrusion rod is fixedly connected with a pressing block, one end of the extrusion rod far away from the pressing block is fixedly connected with a pressing plate, an airbag is fixedly connected to the top of the bottom plate, the top of the bottom plate penetrates through a snap-fit fastener and is slippingly connected with the snap-fit fastener, a pushing plate is fixedly connected to a top of the snap-fit fastener, and a snap-fit block is clamped to a bottom of the snap-fit fastener

Furthermore, a top of the airbag is positioned on a displacement track of the pressing plate, a bottom of the pushing plate is positioned on the displacement track of the airbag, and the snap-fit fastener is fixedly connected with the shaver body through the snap-fit block. Such design improves the accuracy of the device operation, reduces the operation error caused by the position dislocation, and ensures the stable operation of the device.

Furthermore, an inner wall of the protective plate is fixedly connected with a shaver head, a blade is arranged at a top of the shaver head, and the switch is fixedly connected with the snap-fit block through the shaver body. Such design provides additional control and information display, so that the user may easily operate and monitor the state of the shaver body.

Furthermore, an ejection device is arranged at a top of the airbag, the ejection device comprises a connecting plate, a bottom of the connecting plate is fixedly connected to the top of the airbag, a top of the connecting plate is fixedly connected with a pushing rod, an end of the pushing rod far away from the connecting plate is fixedly connected with an ejection plate, the top of the connecting plate is fixedly connected with a buffer rod, and the top of the connecting plate is fixedly connected with a buffer airbag. Such design reduces the operation of the user, improves the convenience of the device, reduces unnecessary operation and reduces a running time of the device.

Furthermore, a buffer spring is fixedly sleeved on a peripheral surface of the buffer rod, and an end of the buffer spring far away from the buffer rod is fixedly connected to the top of the connecting plate. Such design absorbs an impact force in a running process of the device, reduces the shaking in the running process of the device and improves the reliability of the device.

Furthermore, a bottom of the top plate is positioned on a displacement track of the ejection plate, the pushing rod is fixedly connected with the airbag through the connecting plate, and the pushing rod is fixedly connected with the buffer airbag through the connecting plate. Such design enables the top plate to be ejected accurately, reduces the error in an operation process and improves the use comfort of the user.

Furthermore, the bottom plate 51 is fixedly connected with the top plate through the protective plate, two snap-fit fasteners are arranged symmetrically with each other along a vertical central axis of the shaver body, and the airbag is fixedly connected with the release plate through the bottom plate. Such design of symmetrical arrangement on the vertical central axis is conducive to providing more balanced operation and stable performance for the device and makes the device run more smoothly.

Furthermore, two sets of ejection devices are arranged symmetrically with each other along a vertical central axis of the bottom plate, and the top plate is fixedly connected with the connecting plate through the buffer rod. Such design ensures the firm connection among various components, reduces possible failures and looseness, and improves the safety of the device.

A replacement mode of the amorphous alloy shaver having the replaceable shaver head, comprising the following steps of:
S1, pressing the pressing block, driving the pushing plate at the top to move upwards by the airbag, driving the snap-fit fastener at the bottom to move upwards by the pushing plate, so as to separate the snap-fit fastener from the snap-fit block;
S2, driving the connecting plate at the top to move upwards by the airbag, driving the ejection plate at the top of the pushing rod to move upwards by the connecting plate, and pushing the top plate above to separate from the protective plate; and
S3, removing the top plate, and replacing the shaver head and the blade.

The present invention has the following beneficial effects:
1. By means of co-cooperation of a pressing force of a pressing block and components in the replacement device such as an airbag, a pressing plate, a snap-fit fastener and a snap-fit block, the present invention realizes operation of jacking the snap-fit fastener up by the airbag, enhances convenience of a user such that the user replaces a worn shaver head conveniently, prolongs a service life of the shaver, improving operation accuracy of the device, reduces an operation error caused by position dislocation, ensures stable operation of the device, and improves a use comfort degree of the user.
2. By means of the co-cooperation of a driving force of the airbag and the components in the ejection device such as the ejection plate, the connecting plate and the buffer rod, the present invention realizes the operation of ejecting the top plate, reduces the error in the operation process, reduces a hands-on operation procedure, helps to provide more balanced operation and stable performance for the device, makes the operation of the device more smoothly, and ensures the firm connection among various components.

Of course, it is not necessary for implementing any product of the present invention to achieve all the advantages mentioned above at the same time.

### DESCRIPTION OF THE DRAWINGS

In order to explain the technical solution of the embodiments of the present invention more clearly, the drawings needed for the embodiment description will be briefly introduced hereinafter. Obviously, the drawings in the following description are only some embodiments of the present invention. For those ordinary in the field, other drawings can be obtained according to the drawings without creative work.

FIG. 1 is a schematic diagram of a three-dimensional appearance structure of an amorphous alloy shaver having a replaceable shaver head and a replacement mode thereof;

FIG. 2 is a schematic diagram of a three-dimensional enlarged structure at a shaver body of the amorphous alloy shaver having the replaceable shaver head and the replacement mode thereof;

FIG. 3 is a schematic diagram of the three-dimensional enlarged structure at a connecting plate of the amorphous alloy shaver having the replaceable shaver head and the replacement mode thereof;

FIG. 4 is a schematic diagram of the three-dimensional enlarged structure at a pressing block of the amorphous alloy shaver having the replaceable shaver head and the replacement mode thereof; and

FIG. 5 is a schematic diagram of the three-dimensional enlarged structure at an airbag of the amorphous alloy shaver having the replaceable shaver head and the replacement mode thereof.

In figures, a list of components represented by various marks is as follows:

Shaver body 1; release plate 2; switch 3; display screen 4; replacement device 5; bottom plate 51; protective plate 52; top plate 53; extrusion rod 54; pressing block 55; pressing plate 56; airbag 57; snap-fit fastener 58; pushing plate 59; snap-fit block 510; charging slot 6; shaver head 7; blade 8; ejection device 9; connecting plate 91; pushing rod 92; ejection plate 93; buffer rod 94; buffer airbag 95; and buffer spring 96.

### DETAILED DESCRIPTION OF PREFERRED EMBODIMENTS

The technical solution in the embodiments of the present invention will be clearly and completely described hereinafter in combination with the attached drawings. Obviously, the described embodiment is only a part of the embodiment of the present invention, but not the all embodiments thereof. Based on the embodiments of the present invention, all other embodiments obtained by those ordinary in the field without creative work should belong to a protection scope of the present invention.

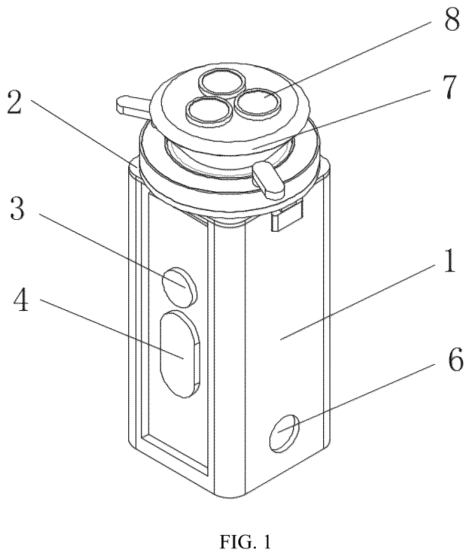

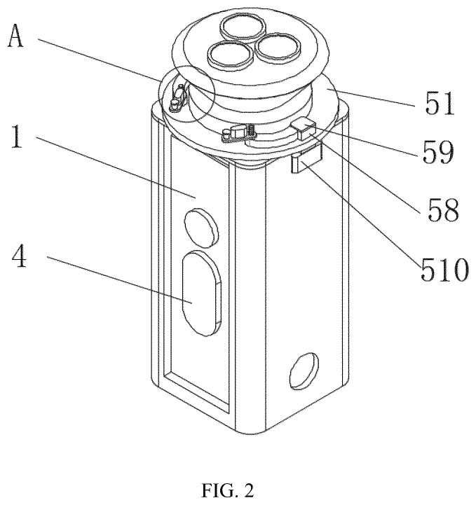

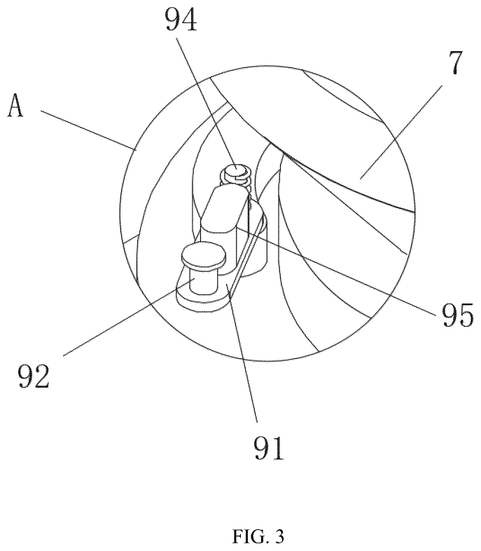

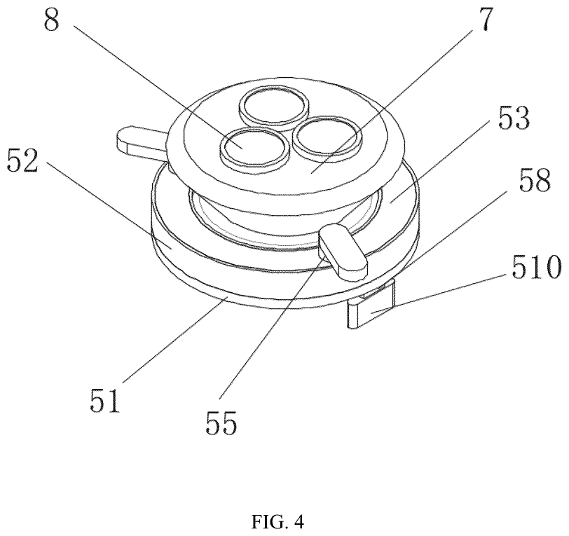

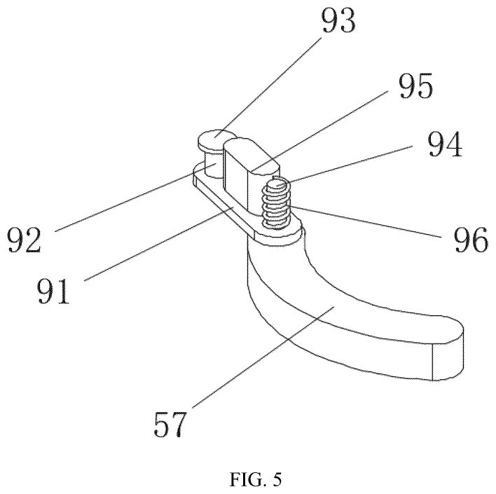

Refer to FIG. 1 to FIG. 5, the present invention refers to an amorphous alloy shaver having a replaceable shaver head, comprising a shaver body 1, wherein a release plate 2 is fixedly connected to a top of the shaver body 1, a side surface of the shaver body 1 is provided with a switch 3, the side surface of the shaver body 1 is provided with a display screen 4, the side surface of the shaver body 1 is provided with a charging slot 6, and a replacement device 5 is arranged at a top of the release plate 2; the replacement device 5 comprises a bottom plate 51, a bottom of the bottom plate 51 is fixedly connected to the top of the release plate 2, a protective plate 52 is fixedly connected to a top of the bottom plate 51, a top plate 53 is clamped to a top of the protective plate 52, a top of the top plate 53 penetrates through an extrusion rod 54 and is slippingly connected with a peripheral surface of the extrusion rod 54, one end of the extrusion rod 54 is fixedly connected with a pressing block 55, one end of the extrusion rod 54 far away from the pressing block 55 is fixedly connected with a pressing plate 56, an airbag 57 is fixedly connected to the top of the bottom plate 51, the top of the bottom plate 51 penetrates through a snap-fit fastener 58 and is slippingly connected with the snap-fit fastener 58, a pushing plate 59 is fixedly connected to a top of the snap-fit fastener 58, and a snap-fit block 510 is clamped to a bottom of the snap-fit fastener 58.

A top of the airbag 57 is positioned on a displacement track of the pressing plate 56, a bottom of the pushing plate 59 is positioned on the displacement track of the airbag 57, and the snap-fit fastener 58 is fixedly connected with the shaver body 1 through the snap-fit block 510. Such design improves the accuracy of the device operation, reduces the operation error caused by the position dislocation, and ensures the stable operation of the device.

An inner wall of the protective plate 52 is fixedly connected with a shaver head 7, a blade 8 is arranged at a top of the shaver head 7, and the switch 3 is fixedly connected with the snap-fit block 510 through the shaver body 1. Such design provides additional control and information display, so that the user may easily operate and monitor the state of the shaver body.

An ejection device 9 is arranged at a top of the airbag 57, the ejection device 9 comprises a connecting plate 91, a bottom of the connecting plate 91 is fixedly connected to the top of the airbag 57, a top of the connecting plate 91 is fixedly connected with a pushing rod 92, an end of the pushing rod 92 far away from the connecting plate 91 is fixedly connected with an ejection plate 93, the top of the connecting plate 91 is fixedly connected with a buffer rod 94, and the top of the connecting plate 91 is fixedly connected with a buffer airbag 95. Such design reduces the operation of the user, improves the convenience of the device, reduces unnecessary operation and reduces a running time of the device.

A buffer spring 96 is fixedly sleeved on a peripheral surface of the buffer rod 94, and an end of the buffer spring 96 far away from the buffer rod 94 is fixedly connected to the top of the connecting plate 91. Such design absorbs an impact force in a running process of the device, reduces the shaking in the running process of the device and improves the reliability of the device.

A bottom of the top plate 53 is positioned on a displacement track of the ejection plate 93, the pushing rod 92 is fixedly connected with the airbag 57 through the connecting plate 91, and the pushing rod 92 is fixedly connected with the buffer airbag 95 through the connecting plate 91. Such design enables the top plate to be ejected accurately, reduces the error in an operation process and improves the use comfort of the user.

The bottom plate 51 is fixedly connected with the top plate 53 through the protective plate 52, two snap-fit fasteners 58 are arranged symmetrically with each other along a vertical central axis of the shaver body 1, and the airbag 57 is fixedly connected with the release plate 2 through the bottom plate 51. Such design of symmetrical arrangement on the vertical central axis is conducive to providing more balanced operation and stable performance for the device and makes the device run more smoothly.

Two sets of ejection devices 9 are arranged symmetrically with each other along a vertical central axis of the bottom plate 51, and the top plate 53 is fixedly connected with the connecting plate 91 through the buffer rod 94. Such design ensures the firm connection among various components, reduces possible failures and looseness, and improves the safety of the device.

A replacement mode of the amorphous alloy shaver having the replaceable shaver head according to any one of claims 1 to 8, comprising the following steps of:
S1, pressing the pressing block 55, driving the pushing plate 59 at the top to move upwards by the airbag 57, driving the snap-fit fastener 58 at the bottom to move upwards by the pushing plate 59, so as to separate the snap-fit fastener 58 from the snap-fit block 510;
S2, driving the connecting plate 91 at the top to move upwards by the airbag 57, driving the ejection plate 93 at the top of the pushing rod 92 to move upwards by the connecting plate 91, and pushing the top plate 53 above to separate from the protective plate 52; and
S3, removing the top plate 53, and replacing the shaver head 7 and the blade 8.

A specific application of the embodiment is as follows: when in use, the pressing block 55 is pressed downward. When the pressing block 55 is pressed by an external force, the pressing block 55 moves downward. The pressing block 55 drives the extrusion rod 54 at the bottom to move downward when moving downward. When the extrusion rod 54 moves downward with a force of the pressing block 55, the extrusion rod 54 drives the pressing plate 56 at the bottom to move downward. When the pressing plate 56 moves downward with a downward force of the pressing rod 54, the pressing plate 56 extrudes the airbag 57 below when moving downward. The airbag 57 is extruded by the pressing plate 56 above, a gas in a side of the airbag 57 is extruded by the pressing plate 56 above, and then the gas in one side flows to the other side. When moving to the other side, the gas in the airbag 57 begins to expand. When one side of the airbag 57 expands upward, the airbag 57 drives the pushing plate 59 at the top to move upward. When the pushing plate 59 is moved upward by an expansion force of the airbag 57, the pushing plate 59 drives the snap-fit fastener 58 at the bottom to move upward. When the snap-fit fastener 58 moves upward with the force of the pushing plate 59, the snap-fit fastener 58 is separated from the snap-fit block 510, thus achieving a separation effect to be divided into two layers. At the same time, when the airbag 57 expands upward, the airbag 57 drives the connecting plate 91 at the top to move upward. When the connecting plate 91 moves upward with the expansion force of the airbag 57, the connecting plate 91 drives the pushing rod 92 at the bottom to move upward. When the pushing rod 92 moves upward with a pushing force of the connecting plate 91, the pushing rod 92 also drives the ejection plate 93 at the top to move upward. When the ejection plate 93 moves upward, the ejection plate 93 pushes the top plate 53 clamped with the protective plate 52, and then the top plate 53 is pushed away from the protective plate 52 by the pushing plate 93 below. Therefore, the automatic operation is achieved, and the hands-on operation procedure is reduced, so that the operation of the device is smoother. At the same time, when the connecting plate 91 moves upward, the connecting plate 91 drives the buffer rod 94, the buffer airbag 95 and the buffer spring 96 at the top to also move upward. The buffer rod 94, the buffer airbag 95 and the buffer spring 96 move upward and are ejected, and then the shaking during the operation of the device is reduced. Then, the top plate 53 is removed, and the shaver head 7 and the blade 8 may be replaced.

In the description of the specification, descriptions referring to the terms of “one embodiment”, “example” and “specific example” mean that specific features, structures, materials or characteristics described in combination with the embodiment or example are included in at least one embodiment or example of the present invention. In this specification, the schematic expressions of the above terms do not necessarily refer to the same embodiment or example. Moreover, the specific features, structures, materials or characteristics described may be combined in any one or more embodiments or examples in a suitable manner.

The preferred embodiments of the present invention disclosed above are only used to help illustrate the present invention. The preferred embodiment does not describe all the details; moreover, the present invention is also not limited to the specific embodiment. Obviously, many modifications and changes can be made according to the contents of the specification. The embodiments are selected and described in detail in the specification in order to better explain the principle and practical application of the present invention, so that those skilled in the art can better understand and utilize the present invention. The present invention is limited only by the claims and full scope and equivalents thereof.

We claim:

1. An amorphous alloy shaver having a replaceable shaver head, comprising a shaver body 1, wherein a release plate 2 is fixedly connected to a top of the shaver body 1, a side surface of the shaver body 1 is provided with a switch 3, the side surface of the shaver body 1 is provided with a display screen 4, the side surface of the shaver body 1 is provided with a charging slot 6, and a replacement device 5 is arranged at a top of the release plate 2; and
the replacement device 5 comprises a bottom plate 51, a bottom of the bottom plate 51 is fixedly connected to the top of the release plate 2, a protective plate 52 is fixedly connected to a top of the bottom plate 51, a top plate 53 is clamped to a top of the protective plate 52, a top of the top plate 53 penetrates through an extrusion rod 54 and is slippingly connected with a peripheral surface of the extrusion rod 54, one end of the extrusion rod 54 is fixedly connected with a pressing block 55, one end of the extrusion rod 54 far away from the pressing block 55 is fixedly connected with a pressing plate 56, an airbag 57 is fixedly connected to the top of the bottom plate 51, the top of the bottom plate 51 penetrates through a snap-fit fastener 58 and is slippingly connected with the snap-fit fastener 58, a pushing plate 59 is fixedly connected to a top of the snap-fit fastener 58, and a snap-fit block 510 is clamped to a bottom of the snap-fit fastener 58.

2. The amorphous alloy shaver having the replaceable shaver head according to claim 1, wherein a top of the airbag 57 is positioned on a displacement track of the pressing plate 56, a bottom of the pushing plate 59 is positioned on the displacement track of the airbag 57, and the snap-fit fastener 58 is fixedly connected with the shaver body 1 through the snap-fit block 510.

3. The amorphous alloy shaver having the replaceable shaver head according to claim 2, wherein an inner wall of the protective plate 52 is fixedly connected with a shaver head 7, a blade 8 is arranged at a top of the shaver head 7, and the switch 3 is fixedly connected with the snap-fit block 510 through the shaver body 1.

4. The amorphous alloy shaver having the replaceable shaver head according to claim 3, wherein an ejection device 9 is arranged at a top of the airbag 57, the ejection device 9 comprises a connecting plate 91, a bottom of the connecting plate 91 is fixedly connected to the top of the airbag 57, a top of the connecting plate 91 is fixedly connected with a pushing rod 92, an end of the pushing rod 92 far away from the connecting plate 91 is fixedly connected with an ejection plate 93, the top of the connecting plate 91 is fixedly connected with a buffer rod 94, and the top of the connecting plate 91 is fixedly connected with a buffer airbag 95.

5. The amorphous alloy shaver having the replaceable shaver head according to claim 4, wherein a buffer spring 96 is fixedly sleeved on a peripheral surface of the buffer rod 94, and an end of the buffer spring 96 far away from the buffer rod 94 is fixedly connected to the top of the connecting plate 91.

6. The amorphous alloy shaver having the replaceable shaver head according to claim 5, wherein a bottom of the top plate 53 is positioned on a displacement track of the ejection plate 93, the pushing rod 92 is fixedly connected with the airbag 57 through the connecting plate 91, and the pushing rod 92 is fixedly connected with the buffer airbag 95 through the connecting plate 91.

7. The amorphous alloy shaver having the replaceable shaver head according to claim 6, wherein the bottom plate 51 is fixedly connected with the top plate 53 through the protective plate 52, two snap-fit fasteners 58 are arranged symmetrically with each other along a vertical central axis of the shaver body 1, and the airbag 57 is fixedly connected with the release plate 2 through the bottom plate 51.

8. The amorphous alloy shaver having the replaceable shaver head according to claim 7, wherein two sets of ejection devices 9 are arranged symmetrically with each other along a vertical central axis of the bottom plate 51, and the top plate 53 is fixedly connected with the connecting plate 91 through the buffer rod 94.

9. A replacement mode of the amorphous alloy shaver having the replaceable shaver head according to claim 1, comprising the following steps of:
S1, pressing the pressing block 55, driving the pushing plate 59 at the top to move upwards by the airbag 57, driving the snap-fit fastener 58 at the bottom to move upwards by the pushing plate 59, so as to separate the snap-fit fastener 58 from the snap-fit block 510;
S2, driving the connecting plate 91 at the top to move upwards by the airbag 57, driving the ejection plate 93 at the top of the pushing rod 92 to move upwards by the connecting plate 91, and pushing the top plate 53 above to separate from the protective plate 52; and
S3, removing the top plate 53, and replacing the shaver head 7 and the blade 8.
